(19) United States
(12) Patent Application Publication
(10) Pub. No.: US 2016/0365592 A1
(43) Pub. Date: Dec. 15, 2016

(54) SOLID WASTE GASIFICATION SYSTEM WITH ANODE GAS RECYCLING ARRANGEMENT

(71) Applicant: KASHONG LLC, Hollywood, CA (US)

(72) Inventors: Matthew H. Fronk, Honeoye Falls, NY (US); Steven G. Goebel, Victor, NY (US); Courtney E. Reich, Fairport, NY (US); Gary M. Robb, Honeoye Falls, NY (US)

(21) Appl. No.: 14/798,551

(22) Filed: Jul. 14, 2015

Related U.S. Application Data
(63) Continuation-in-part of application No. 14/792,668, filed on Jul. 7, 2015.
Application No. 14/792,668 is a continuation-in-part of application No. 14/739,309, filed on Jun. 15, 2015.
Application No. 14/739,309 is a continuation-in-part of application No. 14/739,285, filed on Jun. 15, 2015.

(51) Int. Cl. H01M 8/06

(52) U.S. Cl. CPC H01M 8/0643; H01M 2008/1293

(57) ABSTRACT

A system and method of producing electrical power from a solid waste stream is provided. The system includes a low tar gasification generator that receives a feedstock stream, such as a solid waste stream. The feedstock stream is gasified to produce a first gas stream that includes hydrogen, at least one contaminant and at least one diluent. At least one clean-up process is performed on the first gas stream to remove the at least one contaminant and generate a second gas stream. Electrical power is generated by a solid oxide fuel cell in response to receiving the second gas stream. The solid oxide fuel cell outputting an anode exhaust gas stream. A portion of the anode exhaust gas is vented to reduce the level of diluent in the second gas stream.

### BACKGROUND OF THE DISCLOSURE

The subject matter disclosed herein relates to a system for converting solid waste and, in particular, to a system that controls the recycled exhaust gas of a fuel cell to reduce the accumulation of contaminants.

Traditionally, municipal solid waste was disposed of by dumping of the waste into the ocean, burning in incinerators or burying in landfills. Due to the undesired environmental effects (e.g. release of methane into the atmosphere and contamination of ground water) of these practices, many jurisdictions have prohibited their expansion or implementation. In some parts of the world, gasification technologies have been used to eliminate municipal waste.

Gasification is a process that decomposes a solid material to generate a synthetic gas, sometimes colloquially referred to as syngas. This syngas typically includes carbon monoxide, hydrogen and carbon dioxide. The produced syngas may then be burned to generate steam that drives large gas turbines (50 MW) or internal combustion engines to generate electricity. There are several technologies that are used, including an up-draft gasifier, a down-draft gasifier, a fluidized bed reactor, an entrained flow gasifier and a plasma gasifier. All gasifiers utilize controlled amounts of oxygen to decompose the waste. One issue with current systems is that the use of a gas turbine requires large amounts of waste and correspondingly large amounts of oxygen. As a result, these gasifiers have to be located close to areas where both the waste fuel and oxygen may be readily supplied in large volumes. Further, since steam is generated in the process, to maintain efficiencies the systems need to be located in major industrial complexes where the steam can be used in process or district heating systems.

Accordingly, while existing gasification to electrical power systems have been suitable for their intended purposes the need for improvement remains, particularly in providing a system that can operate at higher efficiency.

### BRIEF DESCRIPTION OF THE DISCLOSURE

According to one aspect of the disclosure a system of producing electrical power from a solid waste stream is provided. The system includes a feedstock module configured to receive at least one feedstock stream. An input module having a low tar gasification generator is configured to produce a first gas stream in response to receiving the at least one feedstock stream, the first gas stream including hydrogen, at least one contaminant and at least one diluent compound. A process module is fluidly coupled to receive the first gas stream, the process module including at least one clean-up process module configured to remove the at least one contaminant from the first gas stream and produce a second gas stream containing hydrogen and at least a portion of the at least one diluent compound. A solid oxide fuel cell (SOFC) is coupled to receive the second gas stream and generate electrical power, the SOFC having an anode exhaust gas stream, wherein the SOFC is fluidly coupled to flow the anode exhaust gas stream to the process module and inject the anode exhaust gas stream into one of the first gas stream or the second gas stream. A vent is fluidly coupled to selectively flow a portion of the anode exhaust gas stream to the environment. A control system is coupled for communication to the vent, the control system having a processor responsive to executable computer instructions for flowing the portion of the anode exhaust gas stream to the environment to reducing a level of the at least one diluent compound in the second gas stream.

According to another aspect of the disclosure a method of producing electrical power from a solid waste stream is provided. The method includes the steps of: receiving a feedstock stream; transferring the feedstock stream into a gasification generator; receiving an gas stream containing oxygen at the gasification generator; producing a first gas stream and residual materials using the gasification generator, the first gas stream including hydrogen, at least one contaminant and at least one diluent compound; generating a second gas stream by performing at least one clean-up process to remove the at least one contaminant from the first gas stream; generating electrical power with a SOFC based at least in part on receiving the second gas stream; outputting an anode exhaust gas stream from the SOFC; injecting the anode exhaust gas stream into the first gas stream prior to the at least one clean-up process; determining a level of the at least one diluent compound in the anode exhaust gas stream; and venting a portion of the anode exhaust gas stream to reducing the level of the at least one diluent compound in the second gas stream in response to determining the level of the at least one diluent compound is above a threshold.

These and other advantages and features will become more apparent from the following description taken in conjunction with the drawings.

### BRIEF DESCRIPTION OF DRAWINGS

The subject matter, which is regarded as the invention, is particularly pointed out and distinctly claimed in the claims at the conclusion of the specification. The foregoing and other features, and advantages of the disclosure are apparent from the following detailed description taken in conjunction with the accompanying drawings in which:

FIG. 1 is a schematic diagram of the system for generating electrical power through the gasification of solid waste in accordance with an embodiment of the invention;

FIG. 2 is a schematic diagram of a feedstock module for use with the system of FIG. 1;

FIG. 3 is a schematic diagram of a gasifier module for use with the system of FIG. 1;

FIG. 4 is a schematic diagram of a process module for use with the system of FIG. 1 in accordance with an embodiment of the invention;

FIG. 5 is a schematic diagram of a process module for use with the system of FIG. 1 in accordance with another embodiment of the invention;

FIG. 6 is a schematic diagram of a power generation module for use with the system of FIG. 1;

FIG. 7 is a flow diagram of a method of operating the system of FIG. 1; and

FIG. 8 is a flow diagram of another method of operating the system of FIG. 1.

The detailed description explains embodiments of the invention, together with advantages and features, by way of example with reference to the drawings.

### DETAILED DESCRIPTION OF THE DISCLOSURE

Embodiments of the invention provide advantages in the high efficiency generation of electrical power from solid waste, such as municipal waste. Embodiments of the invention provide advantages in controlling the level of contaminants in the system when anode exhaust gas is recycled into the system.

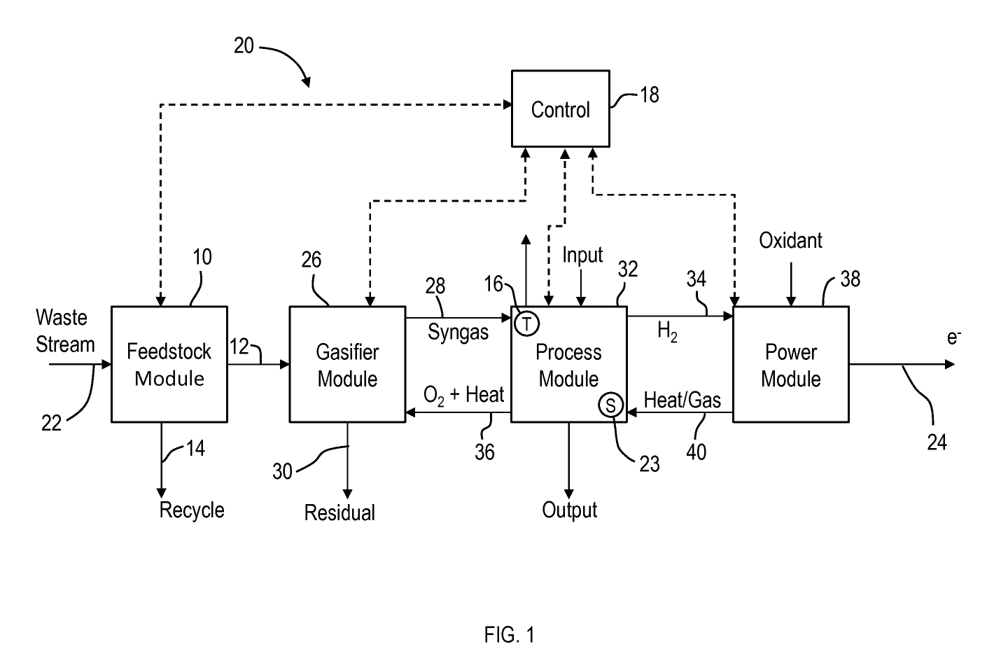

Referring now to FIG. 1, an exemplary system 20 is illustrated for converting a solid waste input stream 22 into generated electrical power 24. The system 20 includes a feedstock module 10 that receives the solid waste stream 22 and outputs a refuse derived feedstock (RDF) 12 and optionally a recycling stream 14 (e.g. separated metals). The RDF 12 is received by a gasifer module 26 that produces a syngas 28 and a residual stream 30. The residual stream 30 may include slag (e.g. a mixture of metal oxides and silicon dioxide) and recovered metals. In one embodiment, the residual stream is recovered and recycled into the manufacture of other products, such as concrete for example.

The syngas 28 is mainly comprised of hydrogen (H₂) and carbon monoxide (CO) along with several non-beneficial compounds. These non-beneficial compounds include contaminant compounds and diluent compounds. As used herein, contaminant compounds are compounds that have an undesirable effect, such as Sulphur (S) poisoning of a fuel cell catalyst for example. Other contaminants may be sequestered by the system 20 to prevent or reduce their introduction into the environment. The contaminant compounds include but are not limited to Sulphur, Chlorine (Cl) and particulates such as alkali salts or heavy metals for example. These contaminant compounds typically are found in trace amounts within the syngas 28 and may be removed within a process module 32 as discussed herein. As used herein, the diluent compounds are inert gases, such as Carbon Dioxide (CO₂), Nitrogen or Nitrogen compounds for example, that may accumulate within the system 20 due to the recycling of anode exhaust gas.

The syngas 28 is transferred from the gasifier module 26 to the process module 32. As will be discussed in more detail herein, the process module 32 modifies the syngas stream 28 to provide an output fuel stream 34 having enhanced composition for the power module 38. To accomplish this, the process module 32 provides several functions, including the quenching of the syngas (reduction in temperature) to reduce or avoid the formation of undesirable compounds (e.g. dioxins and furans), the removal of particulates and solids from the gas stream, and the removal of impurities, diluents or contaminants such as sulfur, nitrogen and carbon dioxide. The process module 32 further conditions the output fuel stream to have the desired pressure, temperature and humidity so that it is suitable for downstream use.

The process module 32 may include a number of inputs, such as but not limited to water, oxygen and solvents such as amine based solvents (e.g. Monoethanolamine). The oxygen input may be used to absorb thermal energy from the syngas 28. Thus, the oxygen stream 36 has an elevated temperature (200 C) when it is transferred to the gasifier module 26. Since the oxygen temperature is increased, the efficiency of the gasification is increased as well. In one embodiment, a steam loop may be used as a heat transfer medium between the syngas and oxygen. Still further advantages may be gained where the thermal energy from said steam loop heated by the syngas stream 28 is used to heat the solid waste stream 22 to reduce the moisture content and improve the quality of the solid waste as a fuel for the gasification process. In one embodiment, the flow rate of the oxygen gas stream 36 may be varied based at least in part on the type of feedstock 22 or the ratio of feedstocks 22 where multiple feedstock streams are used. Where higher energy content feedstock (e.g. tires) is used, less oxidant and a lower torch power is used resulting in lower amounts of Nitrogen and Nitrogen compounds.

The process module 32 further conditions the output fuel stream 34 to have the desired temperature so that it is suitable for downstream use. In one embodiment, the syngas stream 28 exits the gasifier module at a temperature of 700-1000 C. The absorption of thermal energy from the syngas 28 by the oxygen gas stream (through a steam loop) allows the process module to condition the syngas stream for use with clean-up processes that operate at lower temperatures. In some embodiments, these clean-up processes operate at temperatures in the range of 50-450 C. However, as is discussed in more detail herein, in an exemplary embodiment, the downstream process is a power module 38 having a solid oxide fuel cell (SOFC). Since SOFC systems operate at elevated temperatures, such as 700-850 C for example, excess heat in an anode exhaust gas 40 from the power module 38 may be transferred into the process module 32 to elevate the output fuel stream 34 to the desired temperature.

It should be appreciated that the synergistic use and transfer of thermal energy and heat transfer mediums between the modules 26, 32, 38 provides advantages in increasing the efficiency and improving the performance of the system 20.

As will be discussed in more detail herein, in one embodiment the process module 32 may include one or more sensors 16, 23 that provide a signal indicating a measured operating parameter, such as the level of contaminants in the anode exhaust gas 40 for example. The level of contaminants may be determined by a gas analyzer, such as a residual gas analyzer or an infrared gas analyzer for example. In one embodiment, the signal is transmitted to a control system 18, which uses the measured parameter in a closed loop feedback process to provide a desired operating condition, such limiting the level of contaminants in the output fuel stream 34 for example.

The control system 18 is coupled for communication with one or more of the modules 10, 26, 32, 38 for controlling the operation of the system 20. Control system 18 is only one example of a system that includes automated or manual controls of the system 20 and is not intended to suggest any limitation as to the scope of use or functionality of embodiments described herein. Regardless, control system 18 is capable of being implemented and/or performing any of the functionality set forth hereinabove.

Control system 18 is operational with numerous other general purpose or special purpose computing system environments or configurations. Examples of well-known computing systems, environments, and/or configurations that may be suitable for use with control system 18 include, but are not limited to, programmable logic controllers (PLC), personal computer systems, server computer systems, thin clients, thick clients, cellular telephones, handheld or laptop devices, multiprocessor systems, microprocessor-based systems, programmable consumer electronics, network PCs, minicomputer systems, mainframe computer systems, and distributed cloud computing environments that include any of the above systems or devices, and the like.

Control system 18 may be described in the general context of computer system-executable instructions, such as program modules, being executed by the control system 18. Generally, program modules may include routines, programs, objects, components, logic, data structures, and so on that perform particular tasks or implement particular abstract data types. Control system 18 may be practiced in distributed cloud computing environments where tasks are performed by remote processing devices that are linked through a communications network. In a distributed computing environment, program modules may be located in both local and remote computer system storage media including memory storage devices.

Computer system 18 may be in the form of a general-purpose computing device, also referred to as a processing device. The components of control system may include, but are not limited to, one or more processors or processing units, a system memory, and a bus that couples various system components including system memory to processor. Control system 18 may include a variety of computer system readable media. Such media may be any available media that is accessible by computer system/server, and it includes both volatile and non-volatile media, removable and non-removable media. System memory can include computer system readable media in the form of volatile memory, such as random access memory (RAM) and/or cache memory. Control system 18 may further include other removable/non-removable, volatile/non-volatile computer system storage media.

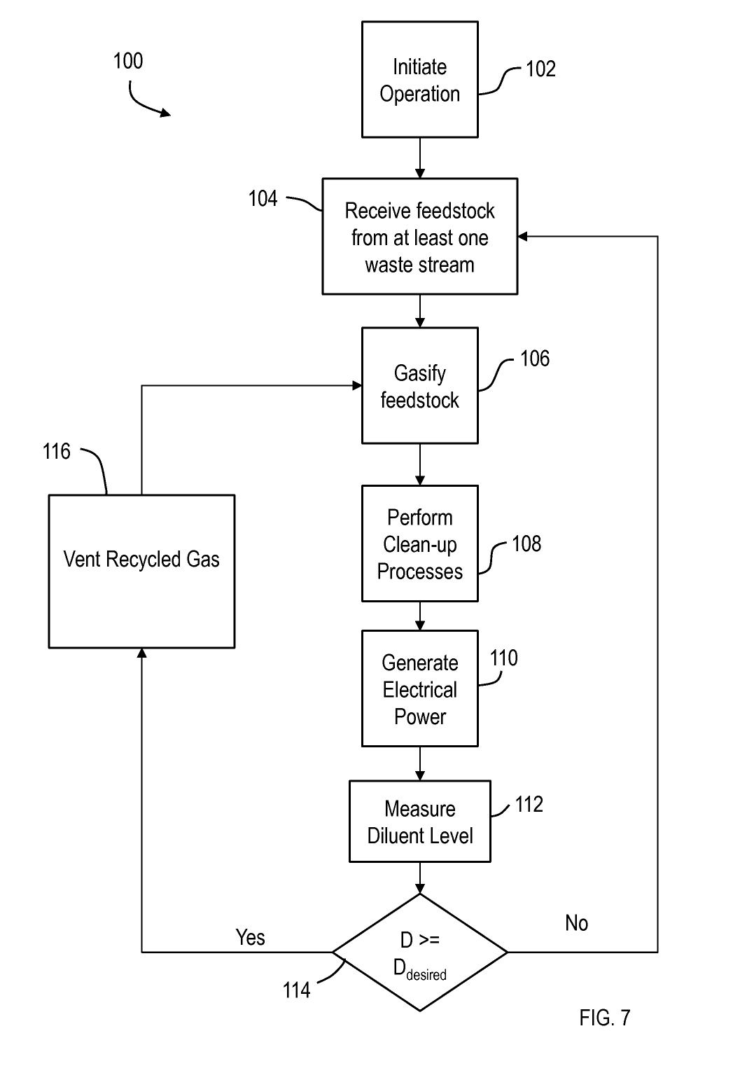

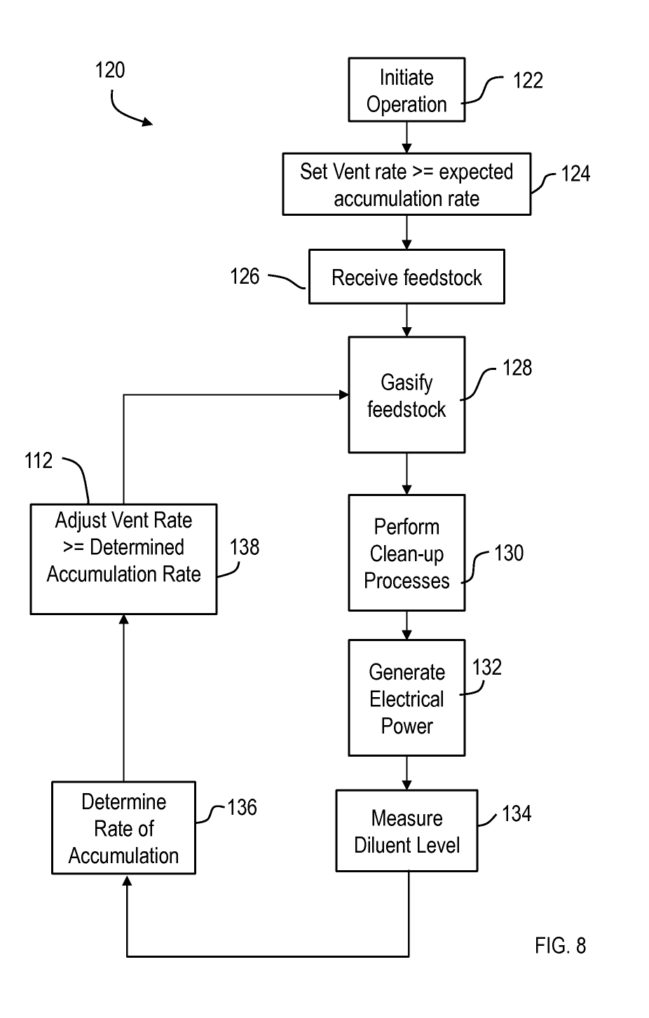

The control system 18 may include a set (at least one) of program modules, may be stored in memory by way of example, and not limitation, as well as an operating system, one or more application programs, other program modules, and program data. Each of the operating system, one or more application programs, other program modules, and program data or some combination thereof, may include an implementation of a networking environment. Program modules generally carry out the functions and/or methodologies of embodiments of the invention as described herein, such as the method illustrated in FIG. 7 or FIG. 8, for example.

Control system 18 may also communicate with one or more external devices such as a keyboard, a pointing device, a display, etc.; one or more devices that enable a user to interact with a computer system/server; and/or any devices (e.g., network card, modem, etc.) that enable control system 18 to communicate with one or more other computing devices. Such communication can occur via Input/Output (I/O) interfaces. Still yet, control system 18 can communicate with one or more networks such as a local area network (LAN), a general wide area network (WAN), and/or a public network (e.g., the Internet) via network adapter. It should be understood that although not shown, other hardware and/or software components could be used in conjunction with control system 18. Examples include, but are not limited to: analog-to-digital (A/D) converters, microcode, device drivers, redundant processing units, external disk drive arrays, RAID systems, tape drives, and data archival storage systems, etc.

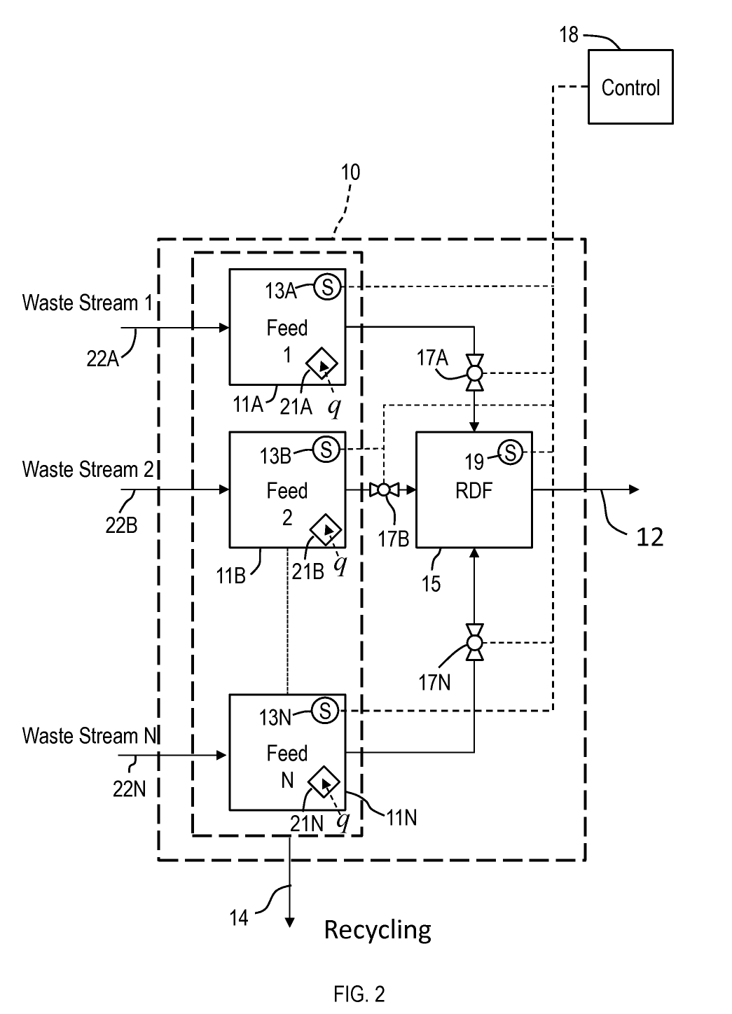

Turning now to FIG. 2, an embodiment of a feedstock module 10 is shown for combining a plurality of feedstock or waste streams 22A, 22B-22N into a single RDF 12. It should be appreciated that any number of feedstock or waste streams 22, including a single stream 22, may be used as an input into the feedstock module 10. For exemplary purposes in describing embodiments here, two waste streams 22A, 22B will be described. Each of the waste streams 22A, 22B has a different energy content. As used herein, the term “energy content” refers to the amount of energy (Btu or Kilojoule) per unit of mass (lb or kilogram). For example, the first waste stream 22A may be composed of waste such as municipal solid waste, which typically has an energy content of 4000-8000 Btu/lb (9304-18608 kJ/kg). The second waste stream 22B may be composed of feedstock such as vehicle tires (typical energy content of 14000 Btu/lb or 32564 kJ/kg) that have higher energy content (relative to municipal solid waste). It should be appreciated that these feedstock streams are for exemplary purposes and the claimed invention should not be so limited. In other embodiments, the feedstock module 10 may include any number N feedstock streams, with each feedstock having different properties, for example energy content. Further, it should be appreciated that the solid waste stream 22A, 22B is not limited to municipal waste and tires, but may include other types of waste such as but not limited to hazardous waste, electronic waste, bio-waste, limestone and coke for example. As discussed in more detail herein, the selective use of higher energy content waste streams may be used to alter the amount of diluent compounds in the syngas stream 28.

The waste streams 22A, 22B are received by a receiver module 11A, 11B. The receiver module 11A, 11B may include sorters that remove recyclable material (e.g. steel, aluminum) and output a recyclable stream 14. Each of the receiver modules 11A, 11B may include one or more sensors 13A, 13B that are coupled to the control system 18. The sensors 13A, 13B may measure parameters such as feedstock temperature or feedstock water content for example. In one embodiment, the sensors 13A, 13B may include a means for determining the quantity of feedstock available, such as by measuring the feedstock weight or using image analysis for example. The feedstock is then transferred to an RDF module 15 that combines the feedstock and outputs the RDF 12. The RDF module 15 may include one or more sensors 19.

In one embodiment, the amount of feedstock from the receiver modules 11A, 11B being transferred to the RDF module 15 may be controlled via switch modules 17A, 17B. The switch modules 17A, 17B may be connected to the control system 18 to allow the control system 18 to selectively transfer material from the receiver modules based on a desired ratio of feedstocks 22A, 22B. In one embodiment, the control system 18 measures a parameter, such as a level of a diluent compound (e.g. Nitrogen) for example, and changes the ratio of feedstocks input into the RDF module 15 to change an operating condition. In one embodiment, the use of higher energy content feedstocks reduces the amount of oxidant used and lowers a torch power in the gasifier, resulting in lower amounts of Nitrogen within the syngas stream 28. As used herein the ratio of feedstocks refers to a quantity of a first feedstock stream to a second feedstock stream that comprises the RDF 12. The quantity may be determined in terms of volume or weight for example.

In one embodiment, rather than or in addition to changing the ratio of the feedstock streams 22A, 22B, the receiver modules 13A, 13B may include means for modifying a condition of the feedstock streams 22A, 22B, such as a heater 21A, 21B that increases the temperature of the feedstock stream 22A, 22B to remove water content (vaporize the water) or dry the feedstock stream. The heater 21A, 21B may be selectively activated by the control system 18 such as in response to the measurement of an operating parameter. The operating parameter may include the temperature of the syngas 28, or be a parameter associated with the feedstock stream such as but not limited to feedstock water content or humidity levels for example. The thermal energy to operate the heaters 21A, 21B may be received from one or more downstream operations where thermal energy is removed from a gas stream or operating process.

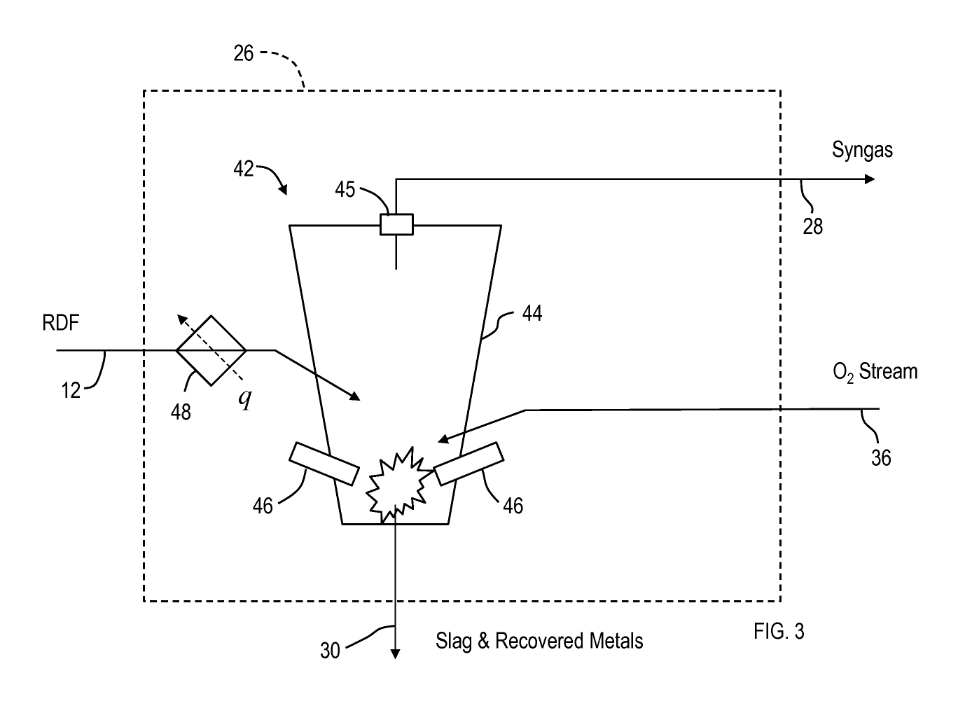

Turning now to FIG. 3, an exemplary gasifier module 26 is shown for converting RDF 12 into a syngas stream 28. In one embodiment, the gasifier module 26 includes a plasma gasifier 42 that is configured to receive the RDF stream 12, the oxygen stream 36 and output the syngas stream 28 and residual stream 30. It should be appreciated that while embodiments herein describe the gasifier module 26 as including a plasma gasifier, this is for exemplary purposes and the claimed invention should not be so limited. In other embodiments, other gasifier technologies that are capable of producing syngas at high temperatures (>1000 C) with low tar may be used. In one embodiment, the gasifier produces a syngas with a tar level of less than or equal to 0.5 mole % and preferably between 0.1-0.5 mole %.

In one embodiment, the gasifier 42 includes an inverted frusto-conical shaped housing 44. In one embodiment, the gasifier 42 includes a plurality of plasma torches 46 that are arranged near the bottom end of the housing 44. The plasma torches 46 receive a high-voltage current that creates a high temperature arc at a temperature of about 5,000 C. It should be appreciated that while FIG. 3 illustrates a single point of entry for the RDF 12, the oxygen stream 36 and two plasma torches, this is for exemplary purposes and the claimed invention should not be so limited. In some embodiments there is a plurality of input ports for the streams 12, 36 disposed about the circumference of the housing 44. In operation, the power level of the torch may be selectively varied based on the type of feedstock being used. For example, a higher energy content feedstock uses a lower torch power than a lower energy content feedstock. Similarly, the oxygen stream 36 may be selectively varied based on the type of feedstock being used.

A plasma arc gasifier breaks the solid waste into elements such as hydrogen and simple compounds such as nitrogen and carbon monoxide by heating the solid waste to very high temperatures with the plasma torches 46 in an oxygen deprived environment. The gasified elements and compounds flow up through the housing 44 to an output port 45 that fluidly couples the housing 44 to the process module 32. The syngas stream 28 exits the gasifier module 22 at a temperature of about 1,000 C. The residual materials 30, typically inorganic materials such as metals and glasses melt due to the temperature of the plasma and flow out of the housing 44 via stream 30 and are recovered.

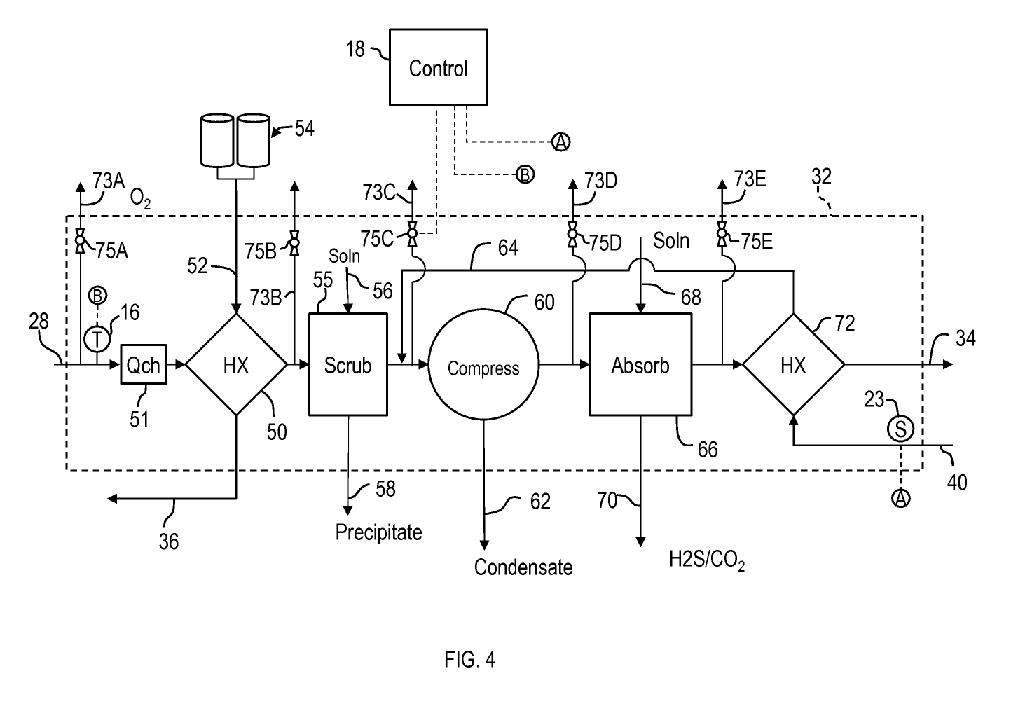

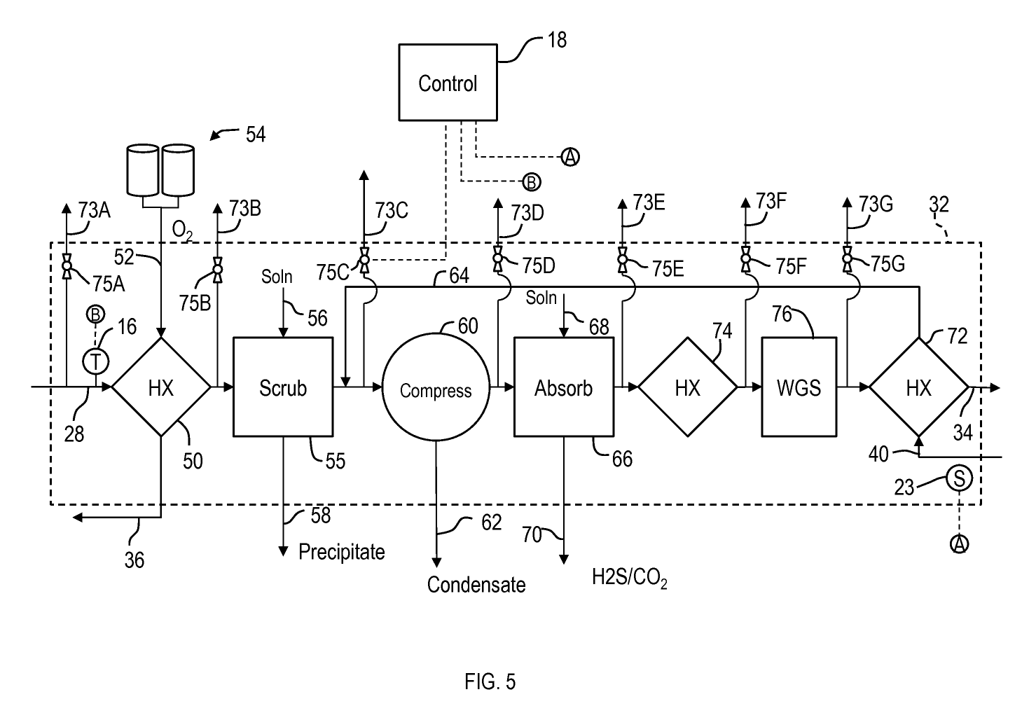

In one embodiment, the gasifier module 26 may include a heat transfer element 48 that transfers a portion of the thermal energy “q” from the heat transfer medium to the RDF 12 prior to the RDF 12 entering the plasma gasifier 42. The heat transfer element 48 may be coupled to receive the heat transfer medium from one or more points within the system 20, such as heat exchangers 50, 72, 74 (FIG. 4-5) for example. It should be appreciated that solid waste, such as municipal waste, may have a high moisture content and it may be desirable to lower this moisture content prior to gasification to improve efficiency. Thus the thermal energy q may be used to dry one or more of the RDF 12. As discussed herein, in one embodiment, the transfer of thermal energy may be selectively applied to the feedstock streams 22A, 22B via heater 21, such as in response to a signal from one of the sensors 13A, 13B for example.

It has further been found that plasma gasifiers provide advantages over other gasifier technologies since they generate very little tar (mixture of hydrocarbons and free carbon) due to the high temperatures used in operation.

Referring now to FIG. 4, an embodiment is shown of the process module 32. The syngas stream 28 is first received by a heat exchanger 50 that reduces the input temperature from about 1,000 C to about 150 C. The process module 32 may include an initial quench water spray 51 that reduces the initial input temperature from 1,000 C to 850 C. The heat exchanger 50 receives an oxygen gas stream 52 and may also receive water for initial quenching and to be used as a heat transfer medium. In one embodiment the oxygen gas stream 52 is received from a liquid oxygen storage unit 54. The oxygen storage unit 54 may include at least two storage units to allow continuous operation of the system 20 when one of the storage units is empty and being replenished.

The oxygen gas stream 52 absorbs thermal energy from the syngas stream 28 as it passes through the heat exchanger 50. In one embodiment, the heated oxygen stream 36 has a temperature of 200 C at a pressure of 10 atm (about 147 psi or 1 megapascal). It should be appreciated that heating the oxygen to the boiling phase change allows for an increase in pressure without the use of a compressor. Providing the oxygen stream 36 with an elevated pressure level provides advantages in increasing the pressure level of the syngas stream 28. As will be discussed in more detail below, a pressurized syngas stream 28 provides further advantages in allowing certain cleaning processes to operate without the use of secondary compression. It should be appreciated that mechanical compression of the syngas would be a parasitic load on the system 20 that would reduce the overall efficiency. In the exemplary embodiment, the system is configured to provide the oxygen gas stream 52 at a pressure sufficient to provide a syngas stream 28 at the output of the gasification module 26 at a pressure greater than about 140 psi (0.95 megapascal).

The cooled syngas stream 28 flows from the heat exchanger 50 to a first clean-up process module 55. In one embodiment, the first clean-up process module 55 is a scrubber that receives a solvent (typically water) input 56 and precipitates contaminant particulates, such as metals (including heavy metals) and dissolves halides and alkali from the syngas stream 28. The first clean-up process module 55 may further remove chlorine from the syngas stream 28. The precipitate stream 58 is captured and removed from the system 20. In one embodiment, the contaminant chlorine is separated from non-contaminant compounds, such as carbon or condensed hydrocarbons for example, and the non-contaminant compounds are transferred back into the system 20.

In one embodiment, once the particulates and some contaminants are removed, the syngas stream 28 flows to an optional compressor 60 that elevates the pressure of the syngas for further processing. In a system with pressurization achieved by boiling of the liquid oxygen supply, the compressor only needs to drive a recirculation flow through the process and power generation modules. The compressor 60 increases the pressure of the syngas stream 28 to 147 psi (1 megapascal). The compressor 60 may include intercoolers that cause water within the syngas stream to condense out of the gas. This condensate is captured and removed from the system via a condensate trap 62. It should be appreciated that since the syngas stream 28 enters the process module 32 at an elevated pressure due to the pressurization performed (and the energy used) by the compressor 60 is considerably less than a system where the syngas stream 28 starts at a lower or ambient pressure. It should be appreciated that for a system without a pressurized gas supply, about 22% of the gross electric output would be required to drive a compressor to elevate the syngas pressure from 1 to 10 atm.

Prior to the compressor 60, an anode exhaust gas stream 64 is injected into the syngas stream 28. As will be discussed in more detail below, this anode exhaust gas stream 64 consists of syngas that was not converted by, and subsequently exits, the SOFC and is recycled back into the process module 32. It should be appreciated that the anode exhaust gas includes diluent compounds, such as Nitrogen water vapor and CO2 for example, that are not consumed by the SOFC. Typically, an SOFC only utilizes a fraction, for example 50% of the incoming fuel. It should be appreciated that advantages are gained by flowing the anode exhaust gas stream 64 prior to compression as the compressor 60 will remove water product from the anode exhaust gas stream 64 and the absorber 66 will remove the CO2 to reduce accumulation of this diluent and other contaminants such as H₂S. Thus while only a small amount of nitrogen is generated by the gasification, the nitrogen may accumulate in the system, via the anode exhaust gas stream 64, unless a separate process is used to remove the nitrogen and other accumulating diluents.

Once the syngas stream 28 has been compressed, the stream enters a second clean-up process module 66. In one embodiment, the second clean-up process module 66 is an amine based absorber that uses an input solvent 68 such as monoethanolamine (MEA) that absorbs and removes contaminants such as sulfur (typically as H2S) and diluents such as CO₂ from the gas stream. These contaminants and diluents are captured and removed via an output stream 70.

In the exemplary embodiment, the power module 38 includes a SOFC. In one embodiment, the SOFC may have a power rating of about 5-15 MW. These fuel cells operate at elevated temperatures in the range of 700-1,000 C. Since the sub-processes of the process module 32 operate at lower temperatures (50-150 C), a heat exchanger 72 receives the processed syngas steam and increases the temperature to a desired temperature, such as above 700 C for example. In the exemplary embodiment, the heat transfer medium 40 is the anode exhaust gas stream 64 received from the SOFC. Thus the heat exchanger 72 provides advantages in both increasing the temperature of the syngas stream from the process module 66 to the desired operating temperature and reducing the temperature of the anode exhaust gas stream 64 to a temperature compatible with the sub-processes of the process module 32. In one embodiment, the anode exhaust gas stream enters the heat exchanger 72 at 850 C and exits at 150 C.

With the temperature of the syngas increased to the desired temperature, the output fuel stream 34 exits the process module 32. It should be appreciated that the process module 32 may include additional processing modules to condition the output fuel stream 34, such as humidifiers for example.

In one embodiment, the process module 32 may include one or more vents 73A-73E. The vents 73A-73E each includes one or more flow control devices, such as a valve 75A-75E for example. The valves 75A-75E may be coupled to control system 18 that selectively opens and closes the valves 75A-75E in response to predetermined thresholds. As will be discussed in more detail herein, in an embodiment, the predetermined threshold may be a diluent compound level for example.

Turning now to FIG. 5, another embodiment is shown of a process module 32. This embodiment is similar to the embodiment of FIG. 4 with an added sub-process module to further enhance the composition of the syngas stream through the reduction of the carbon monoxide. It should be appreciated that a reduction in carbon monoxide also has advantages in improving the solid oxide fuel cell performance. In this embodiment, the syngas stream 28 exits the absorber process module 66 and enters heat exchanger 74 that increases the temperature of the syngas to 250-350 C

With the temperature of the syngas stream 28 at the desired operating temperature, the syngas enters a water-gas shift module 76. In a water-gas shift reaction the syngas is exposed to a catalyst, such as iron oxide-chromium oxide or a copper-based catalyst for example. The water-gas shift module 76 reduces the carbon monoxide content of the syngas stream to less than or equal to 10 percent by converting it with water vapor to additional hydrogen and carbon dioxide. In one embodiment, the water-gas-shift module 76 includes multiple-stages that operate in the 150-450 C temperature range. Each of these stages may be exothermic and additional heat exchangers may be used to remove thermal energy between each stage. It should be appreciated that different catalysts may be used in different stages of the water-gas shift module 76. Steam may be injected into the syngas stream 28 to provide water vapor to enhance the water gas shift reactions occurring within the water-gas-shift module 76. The extracted thermal energy may be either transferred to the environment or in some embodiments transferred to other portions of the system 20, such as the heat exchanger 72 or for drying one or more of the solid waste streams 22A, 22B for example. In one embodiment, the thermal energy is used to drive one or more small gas turbines.

Similar to FIG. 4, the embodiment of FIG. 5 may include one or more vents 73A-73G. The flow to the vents 73A-73G may be controlled by one or more flow control devices, such as valves 75A-75G. The valves 75A-75G may be coupled to control system 18 that selectively opens and closes the valves 75A-75G in response to predetermined thresholds. As will be discussed in more detail herein, in an embodiment, the predetermined threshold may be a diluent compound level for example.

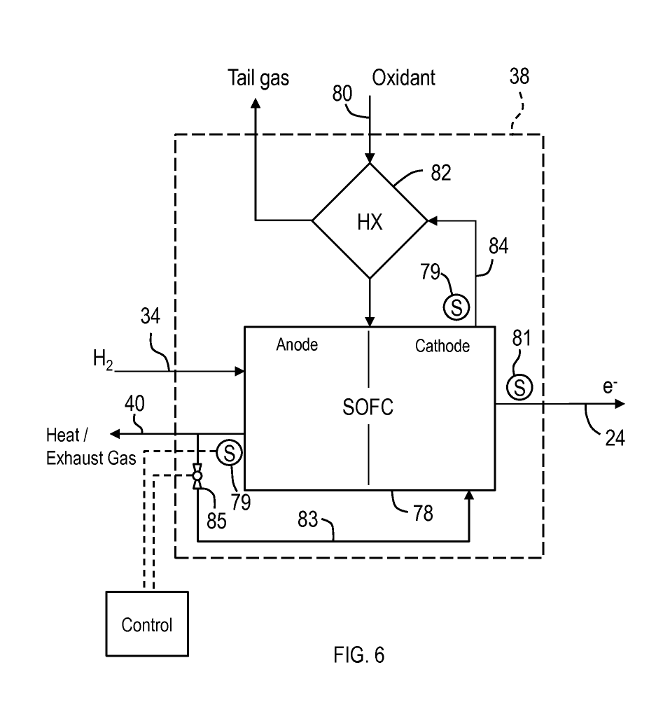

Referring now to FIG. 6, an exemplary power module 38 is shown having a SOFC 78. The output gas stream 34 enters the power module 38 and is received by an anode side of the SOFC 78. A SOFC is an electrochemical conversion device that generates electrical power by the direct oxidation of a hydrogen based fuel. The SOFC uses a solid oxide material as an electrolyte to conduct oxygen ions from a cathode to an anode. The SOFC operates at very high temperatures, typically 700-1,000 C. Thus, the system 20 provides advantages in that the output gas stream 34 may be delivered from the process module 32 at or nearly at the operating temperature of the SOFC.

To produce electrical power 24, the SOFC 78 receives an oxidant, such as air as an input 80 that passes through a heat exchanger 82 where the temperature of the oxidant is increased. The heat exchanger 82 is fluidly coupled to receive cathode tail gas 84 that has been heated by the operation of the SOFC 78. The tail gas 84 passes through the heat exchanger 82 and then exits the system.

It should be appreciated that not all of the hydrogen in the output gas stream 34 may be consumed during operation. During operation, the output gas stream 34 enters the anode side of the SOFC 78 where, in the presence of an anode catalyst, some of the hydrogen combines with the oxygen ions that migrated through the electrolyte. This exchange releases electrons and produces water. Water gas shift reactions also occur within the anode transforming CO and water vapor to CO2 and hydrogen. The water, CO, CO2, unused hydrogen and any diluents from the output gas stream 34 exits the anode side of the SOFC 78. This excess fuel stream 40 exits at or nearly at the operating temperature of the SOFC 78. As discussed herein, this fuel stream passes through the heat exchanger 72, of the process module 32, to preheat the output gas stream 34 and is subsequently recycled back into the process as the anode exhaust gas stream 64.

In one embodiment sensors 79 may be arranged to measure the anode exhaust gas at or adjacent to the output of the anode of the SOFC 78. The sensors 79 may measure an operating parameter, such as diluent levels for example and transmit a signal to the control system 18. In one embodiment, a sensor 81 may be arranged to measure the electrical power and voltage output of the SOFC 78 and provide a feedback signal to the control system 18.

Referring now to FIG. 7, a method 100 of operating the system 20 using a closed loop feedback control circuit to adjust the levels of diluent compounds in the syngas. The method 100 starts in block 102 where operation of the system 20 is initiated. The method 100 then proceeds to block 104 where feedstock is received, such as with receiver modules 13A, 13B for example, from one or more waste streams 22A, 22B. It should be appreciated that at the start of operation, the system 20 may use feedstock from just one waste stream or from a plurality of waste streams depending on the initial conditions, the amounts available and the quality of the waste streams 22A, 22B. The RDF 12 is then transferred to the gasifier module 26 and the feedstock gasified in block 106. The syngas 28 generated by the gasifier 42 is transferred to the process module 32 where the syngas 28 is processed to remove contaminants in block 108.

The method 100 then proceeds to block 110 where electrical power is generated in SOFC 78 by flowing the output gas stream 34 to the anode side of the fuel cell. It should be appreciated that the SOFC 78 is a fuel rich reactor, meaning that the amount of output gas stream 34 supplied is in excess of that which can be utilized by the fuel cell and is also oxygen deficient. Thus the anode exhaust stream 40 contains a large percentage of viable fuel. Thus, the system 20 is arranged to flow the anode exhaust stream back into the syngas stream 28 upstream of the compressor 60, as discussed herein. However, it should be further appreciated that over time, the amount of diluents in the output gas stream 34 (as a percentage of volume) will increase due to the recycling of the anode exhaust gas stream 40.

Since an increase of diluents beyond a threshold will result in an undesired drop in efficiency of the fuel cell, the method 100 measures in block 112 the level of diluents in the anode exhaust gas stream 40, such as with sensor 79 for example. In query block 114, the measured diluent level D is compared to a desired diluent level D_{desired}. It should be appreciated that the desired diluent level may be a threshold (e.g. above a specific value) or may be a range of values (e.g. between a lower and upper threshold). If the query block 114 returns a negative, the method 100 loops back to block 104 and the operation of the system 20 continues. If query block 114 returns a positive, meaning the diluent level in the anode exhaust gas is not below a predefined value, then the method 100 proceeds to block 116. In block 116, a portion of the anode exhaust gas 40 is diverted, sometimes colloquially referred to a bleeding, outside of the system 20. In the exemplary embodiment, a portion of the anode exhaust gas 40 flows via a conduit 83 (FIG. 6) to the cathode side of the SOFC 78 where it is exhausted with the cathode tail gas 84. Although needed to discharge diluents, the bleed will also contain some fuel which will react on the cathode side of the SOFC 78 thus limiting the discharge of any fuel to the exhaust and environment. The flow through the conduit 83 may be controlled via one or more flow control devices, such as valve 85 for example. In one embodiment, the valve 85 is operably coupled to the control system 18. In one embodiment, this bleeding of the anode exhaust gas 40 continues until the diluent levels are below the predetermined threshold. With the feedstock adjusted, the method 100 loops back to block 106 and the process continues.

In another embodiment, rather than venting the anode exhaust gas 40 based on a measurement of diluent levels (such as with sensor 79), the venting occurs on a periodic basis based on the expected accumulation of diluents. Thus the venting occurs on a periodic or aperiodic basis. The time period for venting may be fixed, or may be predicted based at least in part on the operating variables, such as the amount of oxygen/air used in the gasifier 26, the electrical power output of the SOFC 78 or the quality/heating-value of the feedstock 22 for example.

Further, while the method 100 of FIG. 7 describes the venting as occurring at the outlet (or adjacent to the outlet) of the SOFC 78, this is for exemplary purposes and the claimed invention should not be so limited. In other embodiments, the venting may be performed via vents 73C, 73D, 73E for example.

Referring now to FIG. 8, another method 120 is shown for controlling the accumulation of diluents. The method 120 starts in block 122 with the initiation of operation of the system 20. The method 120 then proceeds to block 124 where a vent rate is set to be equal to or greater than the expected accumulation rate. The expected accumulation rate may be based at least in part on historical data or the expected oxygen/air usage for the feedstock being processed for example. The method then proceeds to block 126 where the feedstock 22 is received by the feedstock module 10. The feedstock 22 may be processed as described herein, such as by drying or mixing of different feedstocks together. The processed feedstock or RDF 12 is transferred to the gasifier module 26 in block 128.

The gasifier module 26 produces a syngas stream 28 that flows to the process module 32 in block 130 where it is processed to remove contaminants as described herein. The output gas stream 34 flows from the process module 32 to the SOFC 78 in block 132 and electrical power is generated. As discussed herein, the operation of the SOFC 78 may result in the accumulation of diluents in the anode exhaust gas stream. The level of diluent is measured in block 134 and a rate of accumulation is determined in block 136. It should be appreciated that the rate of accumulation may change over time based at least in part on the amount of oxygen/air that is used by the gasifier module 26 to decompose the feedstock 12.

The method 120 then proceeds to block 138 where the vent rate is set to be equal to or greater than the determined accumulation rate. It should be appreciated that by continuously venting of gas (either anode exhaust gas 40 or syngas 28 downstream from the injection of the recycled anode exhaust gas 64) at a rate equal to or greater than the accumulation rate may maintain the level of diluent in the output gas stream 34 at or below a predetermined threshold for operation of the SOFC 78.

In one embodiment, the venting of anode exhaust gas from the system to reduce diluent levels is performed on a periodic or aperiodic basis rather than continuously. In this embodiment, the determined rate of accumulation is used to determine a time period for the level of diluent to reach a threshold. This time period is then used to determine when the venting should be initiated. In one embodiment, the time period between venting is based on an average rate of accumulation from the determination made in block 136.

It should be appreciated that the level of diluents in the syngas 28 may be due to the feedstock used or the processing conditions within the gasifier, such as whether oxygen or air is used as an oxidant in the gasification process. Where air is used, increased levels of nitrogen and argon may be present in the syngas stream 28 when compared with syngas produced with oxygen. In one embodiment, to adjust the levels of diluents within the system 20 the type of feedstock 22 may be changed to a feedstock that results in lower levels of diluent. In one embodiment, the type of feedstock 22 is changed to a feedstock that allows for a lower flow of oxidant during the gasification process. In still further embodiments, the methods 100, 120 may activate one or more of the heaters 21A, 21B or heat transfer element 48 to dry or reduce the water content of the feedstock streams 22A, 22B or RDF 12.

It should be appreciated that the control system 18 may incorporate additional variables into the adjustment of the feedstock, such as from sensors 13A, 13B, 19 for example. In this embodiment, the adjustment of the feedstock ratios may factor for variables that include and are not limited to: the water content of the waste stream; the volume of waste stream available; and, the temperature of the waste stream for example.

It should be appreciated that embodiments of the invention provide advantages in allowing the gasification of solid waste to produce electrical power. Embodiments of the invention allow for the increase in efficiency of the system by recycling and utilization of waste anode exhaust gas that would normally be dissipated in the ambient environment. Still further embodiments of the invention provide advantages in decreasing the levels of in the process module output stream to increase the efficiency of the SOFC.

The term “about” is intended to include the degree of error associated with measurement of the particular quantity based upon the equipment available at the time of filing the application. For example, “about” can include a range of ±5%, or 2% of a given value.

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, element components, and/or groups thereof.

While the disclosure is provided in detail in connection with only a limited number of embodiments, it should be readily understood that the disclosure is not limited to such disclosed embodiments. Rather, the disclosure can be modified to incorporate any number of variations, alterations, substitutions or equivalent arrangements not heretofore described, but which are commensurate with the spirit and scope of the disclosure. Additionally, while various embodiments of the disclosure have been described, it is to be understood that the exemplary embodiment(s) may include only some of the described exemplary aspects. Accordingly, the disclosure is not to be seen as limited by the foregoing description, but is only limited by the scope of the appended claims.

What is claimed is:

1. A system for generating electrical power from solid waste material, the system comprising:
a feedstock module configured to receive at least one feedstock stream;
an input module having a low tar gasification generator configured to produce a first gas stream in response to receiving the at least one feedstock stream, the first gas stream including hydrogen, at least one contaminant and at least one diluent compound;
a process module fluidly coupled to receive the first gas stream, the process module including at least one clean-up process module configured to remove the at least one contaminant from the first gas stream and produce a second gas stream containing hydrogen and at least a portion of the at least one diluent compound;
a solid oxide fuel cell (SOFC) coupled to receive the second gas stream and generate electrical power, the SOFC having an anode exhaust gas stream, wherein the SOFC is fluidly coupled to flow the anode exhaust gas stream to the process module and inject the anode exhaust gas stream into one of the first gas stream or the second gas stream;
a vent fluidly coupled to selectively flow a portion of the anode exhaust gas stream to the environment; and
a control system coupled for communication to the vent, the control system having a processor responsive to executable computer instructions for flowing the portion of the anode exhaust gas stream to the environment to reducing a level of the at least one diluent compound in the second gas stream.

2. The system of claim 1, further comprising a sensor operably coupled to the anode exhaust gas stream, the sensor configured to measure an operating parameter.

3. The system of claim 2, wherein the control system is coupled for communication to the sensor, the processor being further responsive to flowing the portion of the anode exhaust gas stream to the environment in response to the measurement of the operating parameter.

4. The system of claim 3, wherein the operating parameter is a level of diluent compound in the anode exhaust gas stream.

5. The system of claim 1, wherein the SOFC includes an anode side and a cathode side, the vent being configured to flow the portion of the anode exhaust gas stream to the cathode inlet side.

6. The system of claim 1, wherein the vent is fluidly coupled to the process module downstream from the at least one clean-up process module.

7. The system of claim 1, wherein the vent is fluidly coupled to the process module upstream from the at least one clean-up process module.

8. The system of claim 1, wherein the processor is further responsive to executable instructions for determining a rate of accumulation of diluent in the anode exhaust gas stream.

9. The system of claim 8, wherein the processor is further responsive on a periodic or aperiodic time period to flow the portion of the anode exhaust gas stream to the environment in response to determining the rate of accumulation of diluent.

10. The system of claim 8, wherein the processor is further responsive to changing a flow rate of the portion of the anode exhaust gas stream to the environment in response to determining the rate of accumulation of diluent.

11. The system of claim 1, wherein the at least one feedstock stream includes a first feedstock stream and a second feedstock stream, the second feedstock stream being different from the first feedstock stream, the processor further being responsive to changing from the first feedstock stream to the second feedstock stream to reducing the level of the at least one diluent compound in the second feedstock stream.

12. A method of producing electrical power from a solid waste stream comprising:
receiving a feedstock stream;
transferring the feedstock stream into a gasification generator;
receiving an gas stream containing oxygen at the gasification generator;
producing a first gas stream and residual materials using the gasification generator, the first gas stream including hydrogen, at least one contaminant and at least one diluent compound;
generating a second gas stream by performing at least one clean-up process to remove the at least one contaminant from the first gas stream;
generating electrical power with a SOFC based at least in part on receiving the second gas stream;
outputting an anode exhaust gas stream from the SOFC;
injecting the anode exhaust gas stream into the first gas stream prior to the at least one clean-up process;
determining a level of the at least one diluent compound in the anode exhaust gas stream; and
venting a portion of the anode exhaust gas stream to reducing the level of the at least one diluent compound in the second gas stream in response to determining the level of the at least one diluent compound is above a threshold.

13. The method of claim 12, wherein the step of determining the level of at least one diluent compound includes measuring a first operating parameter associated with the anode exhaust gas stream.

14. The method of claim 13, wherein the first operating parameter is a level of diluent compound in the anode exhaust gas stream adjacent the SOFC.

15. The method of claim 12, wherein the step of venting a portion of the anode exhaust gas stream includes flowing the portion of the anode exhaust gas stream to a cathode inlet side of the SOFC.

16. The method of claim 12, further comprising determining a rate of accumulation of diluent in the anode exhaust gas stream.

17. The method of claim 16, wherein the step of venting the portion of the anode exhaust gas stream including venting on a periodic or aperiodic basis based at least in part on the determined rate of accumulation.

18. The method of claim 16, further comprising changing a rate of flow of the portion of the anode exhaust gas stream based at least in part on the determined rate of accumulation.

19. The method of claim 12, wherein the feedstock stream includes a first feedstock stream and a second feedstock stream.

20. The method of claim 19, further comprising changing from the first feedstock stream to the second feedstock stream in response to determining the level of the at least one diluent compound is above the threshold.
